(19) United States
(12) Patent Application Publication
(10) Pub. No.: US 2006/0051181 A1
(43) Pub. Date: Mar. 9, 2006

(54) Universal clinch base

(76) Inventor: George R. Winton III, Lawrenceville, GA (US)

Correspondence Address: GEORGE R. WINTON, 242 ASHBOURNE TR., LAWRENCEVILLE, GA, 30043, US

(21) Appl. No.: 11/222,263

(22) Filed: Sep. 8, 2005

Related U.S. Application Data
(60) Provisional application No. 60/644,434, filed on Jan. 18, 2005.
(60) Provisional application No. 60/607,582, filed on Sep. 8, 2004.
(60) Provisional application No. 60/607,583, filed on Sep. 8, 2004.

(51) Int. Cl. F16B 37/04

(52) U.S. Cl. 411/180

(57) ABSTRACT

A round metal clinch-type base is used to support numerous downstream applications. Once the inventive hybrid assembly (metal base+application top) is installed in a thin sheet panel, the application top is free to rotate in a plane parallel to the surrounding sheet panel.

Priority based upon provisional applications:

Ser. No. 60/644,434, Universal Clinch Base, Jan. 18, 2005, Ser. No. 60/607,582, Self-clinching Platform, Sep. 8, 2004, and Ser. No. 60/607,583, Omni-directional Mount, Sep. 8, 2004 is hereby claimed.

### BACKGROUND

1. Field of Invention

The present invention relates self-clinching fasteners. The inventive fastener provides for a self-clinching steel base used to support numerous applications such as a right angle bracket and a cable tie fastener.

2. Description of Prior Art

In the design of sheet metal components, self-clinching fasteners are commonly used to secure various components to a sheet metal surface. Round self-clinching studs and nuts are common. Rectangular self-clinching right angle brackets and cable tie fasteners are recent inventions that secure various objects to a sheet panel.

An example of a self-clinching bracket was disclosed by Ross in U.S. Pat. No. 5,810,501. Ross makes use of a rectangular cutout in a sheet panel for installation.

An example of a self-clinching cable tie fastener was disclosed by Winton in U.S. Pat. No. 6,190,083. Winton describes a rectangular self-clinching fastener that is intended to secure a cable tie to a thin sheet panel. Winton also uses a rectangular cutout in a sheet panel to mount the cable tie fastener.

Another example of a cable tie mount was disclosed by Kuffel in U.S. Pat. No. 5,472,159. Kuffel describes a snap-in type fastener that is used to secure a cable tie to a thin sheet of metal. Kuffel also makes use of a rectangular cutout in the sheet panel.

One of the disadvantages of the above prior arts is that a rectangular hole must first be orientated in a sheet panel before the fastener is secured to the sheet panel. Another disadvantage of the above prior arts is the lack of flexibility of the fastener to rotate once installed into a sheet panel.

An example of a round fastener that provides for freedom of rotation once fastened to a sheet panel is described by Image Industries; see marketing literature provided. Image shows a wire management product intended to secure a cable tie once the fastener is welded to a sheet panel.

The disadvantage of the Image fastener is the technique used to secure the fastener to a sheet panel. The Image fastener is installed using a welding technique and thus the process itself tends to melt the plastic top used to secure a cable tie. Another disadvantage of the Image fastener is the lack of precision of placement onto a sheet panel. The weld stud process is not as accurate as those fasteners installed into a precision punched cutout such as a self-clinching fastener.

None of the above prior arts make use of a round self-clinching base that permits the freedom of rotation after installed into a thin sheet panel.

The current invention makes use of a round self-clinching base with the addition of a permanently attached rotational member. The attached rotational member can take on numerous shapes, sizes, and can be made from several materials such as plastic or steel. The common thread from application to application is the round self-clinching base. It is this aspect of the inventive base that serves as a platform for a wide variety of applications.

### SUMMARY OF THE INVENTION

Accordingly, several objects and advantages of my invention are:

(a) to provide a common self-clinching base to serve as a platform for solving several technical problems whereby the application end of the fastener is able to only rotate in a plane parallel to the surrounding sheet pane; and

(b) to give a end user the ability of using a round hole to install a right angle bracket and/or a cable tie mount.

Still further objects and advantages will become apparent from a consideration of the ensuing description and drawings.

### DESCRIPTION OF THE DRAWINGS

FIG. 1 shows an isometric view of the inventive base 10;

FIG. 2 shows a front view of the FIG. 1;

FIG. 3 shows a side view of FIG. 1;

FIG. 4 shows the inventive base with a plastic top 20, the application being a cable tie mount that rotates once installed;

FIG. 5 shows a front view of FIG. 4;

FIG. 6 shows a front view if FIG. 4 pressed into a thin sheet panel;

FIG. 7 shows the inventive base with a plastic top 50, the application being a right angle bracket that rotates once installed;

FIG. 8 shows the a front view of FIG. 7;

FIG. 9 shows the inventive base with a plastic top 60, the application being an omni-directional cable tie mount; and

FIG. 10 shows a front view of FIG. 9.

FIG. 11 shows an isometric view of an omni-directional fastener 80.

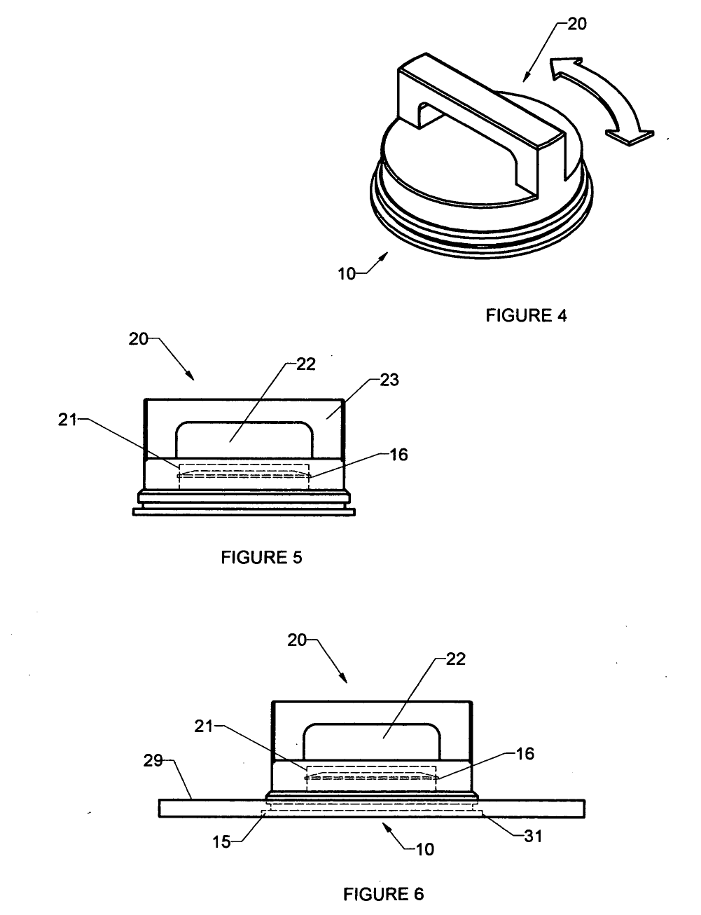

Bi-directional arrows in FIGS. 4, 7, and 9 indicate that the application is free to rotate once installed into a sheet panel. The direction of rotation is within a plane parallel to the plane containing the bi-directional arrow itself. The bi-directional arrows lie parallel to a plane of the surrounding sheet panel.

### DESCRIPTION OF THE PREFERRED EMBODIMENT

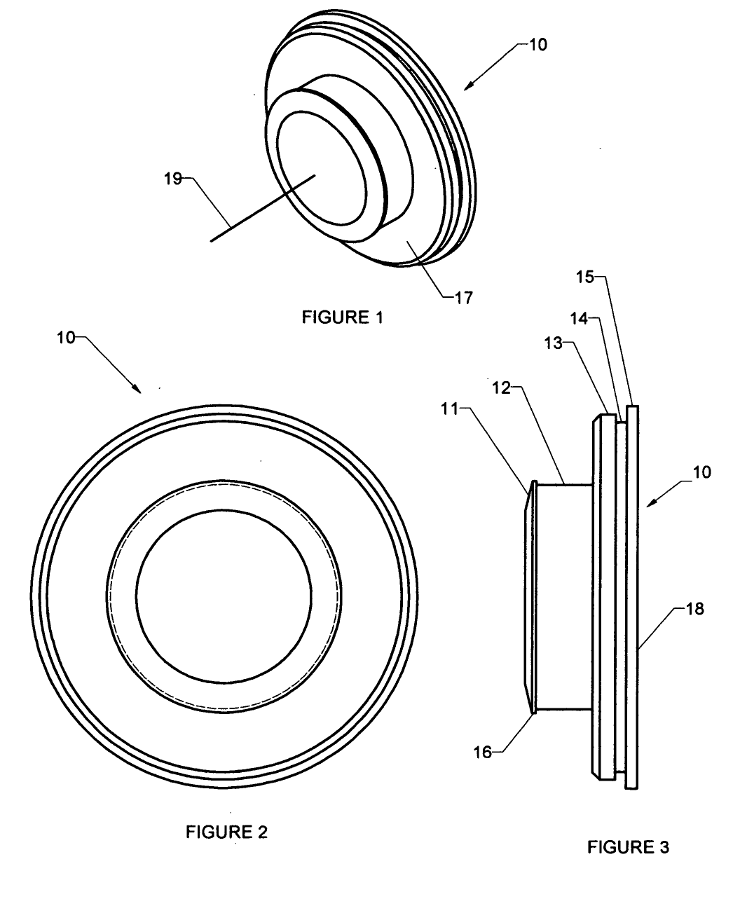

From FIGS. 1, 2 and 3, the inventive self-clinching base 10 is shown. Base 10 has a lead 11. Attached to lead 11 is a barb 16. Adjacent to barb 16 is a reduced right-angle cylinder 12. Cylinder 12 when combined with barb 16 and lead 11 form a means of attachment.

Adjacent to reduced cylinder 12 is body 13. Formed adjacent to body 13 is an undercut groove 14. Formed adjacent to undercut groove 14 is an extended land 15.

The diameter of barb 16 is larger than the diameter of cylinder 12. The diameter of cylinder 12 and barb 16 is smaller than the diameter of body 13. Undercut groove 14 is smaller than the diameter of body 13 and extended land 15. Extended land 15 is larger in diameter than the diameter of body 13. All features/diameters are concentric with an axis 19. Extended land 15 has a face 18. Face 18 is opposite lead 11.

From FIGS. 4, 5, and 6, a cable tie mount 20 (1^{st} application top) is shown secured to base 10. Barb 16 is forced into a round hole 21 formed into the mating side of cable mount 20. Hole 21 is slightly smaller than the outside diameter of barb 16. When the two features are forced to mate, barb 16 is pressed into hole 21 thus forming a means of attachment. Once mount 20 is mated to base 10, a slight force will cause mount 20 to rotate about a plane shown by the bi-directional arrow in FIG. 4. Thus, mount 20 would be allowed to rotate about axis 19. However, mount 20 will be prevented from separating from base 10 along axis 19 due to the interference between barb 16 and hole 21.

Opening 22 is formed by U shape 23. In operation, U shape 23 allows a cable tie 67 to pass thru opening 22.

From FIG. 6, a sheet panel 29 is shown with a hole 31. Hole 31 is round in shape and formed in sheet panel 29.

In operation, from FIGS. 1 thru 6 a cable tie mount application is shown. Base 10, with cable mount 20 already attached, is first passed thru hole 31 in sheet 29. As base 10 passes thru sheet panel 29, extended land 15 will contact sheet panel 29. As force is applied to base 10 via face 18 in a direction towards sheet panel 29, material from sheet panel 29 will be forced (cold flow) into undercut groove 14 thus self-clinching base 10 to sheet panel 29. Therefore, material from sheet panel 29 is forced into undercut groove 14 when extended land 15 forces (displaces) material 29 to cold flow into groove 14. Hole 31 in sheet panel 29 is larger than body 13 yet smaller than the diameter of extended land 15.

The process of self clinching is well documented in the prior arts cited above. A further description of the self-clinching process can be found in U.S. Pat. No. 6,079,923 and U.S. Pat. No. 3,770,037.

The assembly of base 10 and mount 20 is then self-clinched into a sheet panel 29 as shown in FIG. 6. Once face 18 is flush with sheet panel 29, able tie 67 is free to pass thru opening 22 and thus is captivated by U shape 23.

In operation, mount 20 is free to rotate about a plane parallel to the major plane of sheet material 29. This rotational movement thus provides an end user the ability to re-positions the mount 20 to a suited position while at the same time the interface between barb 16 and hole 21 prevents mount 20 from dislodging from one another.

Male barb 16 and female hole 21 provide for a secure fit between base 10 and mount 20. Nevertheless, the male/female roles can be reverse and still provide for the same overall function.

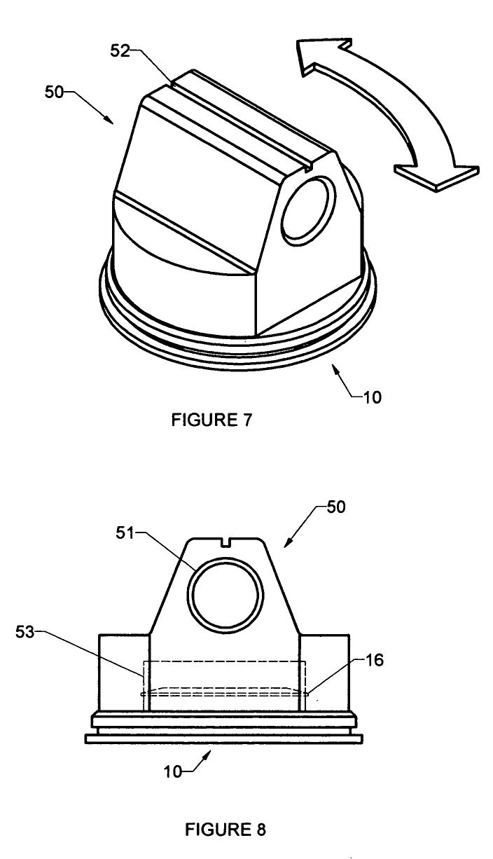

From FIGS. 7 and 8, inventive base 10 is shown with a bracket application 50 (2^{nd} application top). Application 50 has a thru hole 51 that is perpendicular to axis 19. At the top of application 50 opposite base 10 is a slot 52. Slot 52 is used to rotate bracket 50 once the overall assembly (base 10+bracket 50) is installed in sheet panel 29 in the same manor as that shown in FIG. 6. As with cable mount 20, bracket 50 has a hole 53 that is intended to interface with barb 16. The intent of barb 16 is to secure bracket 50 to base 10. Once secured, by turning bracket 50 via slot 52, bracket 50 is only able to rotate about axis 19. Hole 51, tapped or not, serves as a common attachment point for a mating panel. A screw driver is thus able to position the threaded hole via slot 52 once the overall assembly is self-clinched into a mating sheet panel.

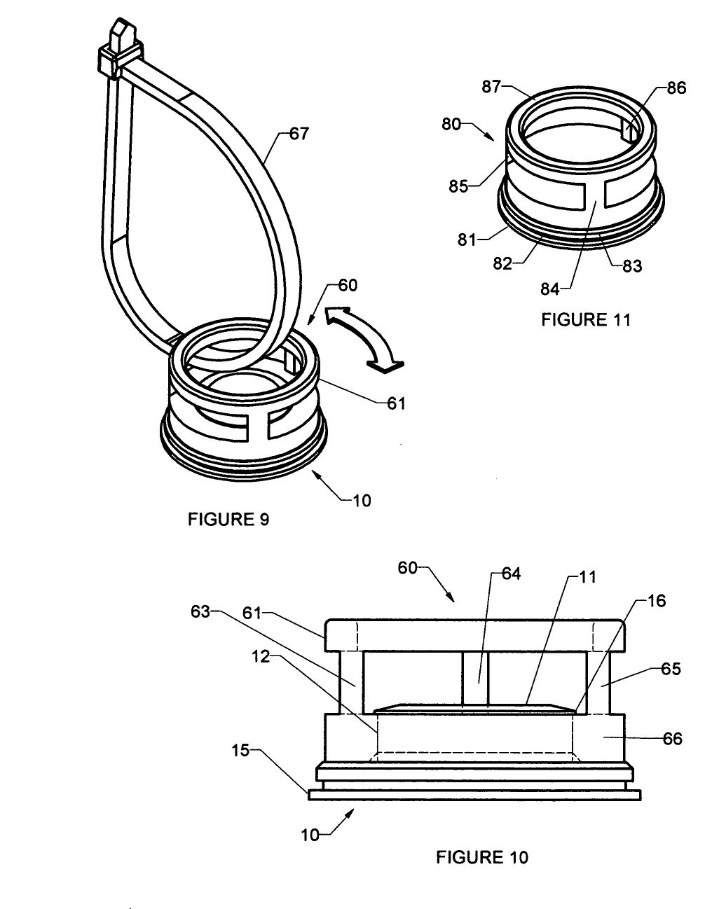

Still other forms of interfaces can be employed between base 10 and an intended application top. For instance, FIGS. 9 and 10 both show inventive base 10 secured to an omni-directional cable tie mount 60 (3^{rd} application top). Cable tie mount 60 shows a thru hole 62. Lead 11 and barb 16 form a rivet like head and thus protrudes outside of hole 62. In this configuration, with the rivet like head (lead 11+barb 16) outside and adjacent to hole 62, application 60 is only free to rotate about axis 19.

Omni top 60 has a top ring 61 supported by three posts 63, 64, and 65. The three supporting posts 63, 64, and 65 join to a supporting base 66. Cable tie 67 is then able to pass thru any of the openings formed between ring 61 and supporting base 66. The omni-directional aspects of the mount 60 allows a cable tie to pass thru ring 61 from any directional angle without first rotating mount 60 about axis 19.

From FIG. 11, an omni-directional fastener 80 is shown. Fastener 80 is a combination of base 10 and mount 60 fabricated as one component. Fastener 80 has an extended land 81, undercut groove 82, base, 83, three posts 84, 85, and 86. Posts 84, 85, and 86 support a ring 87. The self-clinching features on fastener 80 are the same as base 10. The posts 84, 85, and 86 along with ring 87 are the same as described in mount 60. In this application, base 10 can be combined with mount 60 to form 1 component because mount 60 is able to receive a cable tie from any direction without first rotating mount 60 about axis 19.

In application, fastener 80 is clinched to a sheet panel using the known self-clinching techniques described above. Once installed in a sheet panel, fastener 80 is ready to receive a cable tie fastener from any direction.

The intent of the inventive base is to only provide for relative rotational motion between the inventive base and the intended application in a plane established by the surrounding sheet panel.

Still other self-clinching base techniques may be employed to arrive at a solution intended to provide a platform that allows only rotational motion when installed into sheet panel 29.

All figures show various applications making use of a round self-clinching base. Other applications, for example, door hinges, can be rendered form making use of a common self-clinching base.

The material of base 10 is not limited to steel. Such materials as bronze or aluminum may be used. The same holds true for the applied applications joined to base 10. Nylon is one material that is well suited for numerous applications such as a cable tie mount. Delrin, bronze, or steel are quite suited for the application shown in FIG. 9.

Barb 16 is shown on base 10. Adding more than one barb to a base would only improve the bound strength between a specific base and an intended application while allowing relative rotational motion.

Most applications described share a similar hole 21 as shown in FIG. 6. These holes press onto barb 16 found on base 10. This is common in most applications. Nevertheless, the means of attachment between base 10 and various applications is not limited to the hole/barb approach as further described by inventive base 10 shown in FIGS. 9 and 10; i.e, the rivet head approach. The intent of the invention is to provide a self-clinching base that will, when self-clinched into a surrounding sheet panel will allow a specific application to only rotate about axis 19.

Other configurations can be envisioned. For example from FIG. 11, base 10 is combined with omni-directional top 60. In this example both base 10 and top 60 would be made form steel and top 60, because it is omni-directional, would have no need to rotate about axis 19. Thus, base 10 and top 60 could be fabricated as one component and still allow a cable tie to pass thru ring 61 from any directional angle.

What is claimed is:

1. A metal, clinch-type base, comprising:
a round rigid metal extended land formed adjacent to an undercut groove, formed adjacent to said undercut groove is a body, formed adjacent to said body is an attachment means, said attachment means is intended to secure a mating part and thus allow only relative rotational motion between said clinch-type base and a mating part.

2. A metal, clinch-type base, comprising:
a round rigid metal extended land formed adjacent to an undercut groove, formed adjacent to said undercut groove is a body, formed adjacent to said body are three posts, said three posts support a ring, said ring lies in a plane parallel to said extended land.
